(19) United States
(12) Patent Application Publication
(10) Pub. No.: US 2013/0178096 A1
(43) Pub. Date: Jul. 11, 2013

(54) QUICK MOUNT CONNECTOR FOR A COAXIAL CABLE

(71) Applicant: Michael Ole Matzen, Vordingborg (DK)

(72) Inventor: Michael Ole Matzen, Vordingborg (DK)

(21) Appl. No.: 13/732,679

(22) Filed: Jan. 2, 2013

Related U.S. Application Data
(60) Provisional application No. 61/583,385, filed on Jan. 5, 2012.

(51) Int. Cl. H01R 24/38

(52) U.S. Cl. CPC H01R 24/38
USPC 439/578

(57) ABSTRACT

A post-less coaxial cable connector includes a body, a shell, a compression ring, and a coupling portion. The shell has a collapsible groove that, when the post-less coaxial cable connector is axially compressed, collapses and engages the coaxial cable. This provides pull strength and electrical communication in the post-less coaxial cable connector. The compression ring has projections, that when the post-less coaxial cable connector is axially compressed, engage the coaxial cable jacket, providing sealing at the back end and rotation torque.

### RELATED APPLICATIONS

This application claims the benefit of priority under 35 U.S.C. §119 of U.S. Provisional Application Ser. No. 61/583,385 filed on Jan. 5, 2012 the content of which is relied upon and incorporated herein by reference in its entirety.

### BACKGROUND

1. Field

The present invention relates generally to coaxial cable connectors, and particularly to quick mount Type F connectors for use with minimally prepared coaxial cables.

2. Technical Background

Coaxial cable connectors such as F-connectors are used to attach coaxial cables to another object such as an appliance or junction having a terminal adapted to engage the connector. Coaxial cable F-connectors are often used to terminate a drop cable in a cable television system. The coaxial cable typically includes a center conductor surrounded by a dielectric, in turn surrounded by a conductive grounding foil and/or braid (hereinafter referred to as a conductive grounding sheath); the conductive grounding sheath is itself surrounded by a protective outer jacket. The F-connector is typically secured over the prepared end of the jacketed coaxial cable, allowing the end of the coaxial cable to be connected with a terminal block, such as by a threaded connection with a threaded terminal of a terminal block.

Crimp style F-connectors are known wherein a crimp sleeve is included as part of the connector body. A special radial crimping tool, having jaws that form a hexagon, is used to radially crimp the crimp sleeve around the outer jacket of the coaxial cable to secure such a crimp style F-connector over the prepared end of the coaxial cable.

Still another form of F-connector is known wherein an annular compression sleeve is used to secure the F-connector over the prepared end of the cable. Rather than crimping a crimp sleeve radially toward the jacket of the coaxial cable, these F-connectors employ a plastic annular compression sleeve that is initially attached to the F-connector, but which is detached therefrom prior to installation of the F-connector. The compression sleeve includes an inner bore for following such compression sleeve to be passed over the end of the coaxial cable prior to installation of the F-connector. The end of the coaxial cable must be prepared by removing a portion of the outer braid and/or folding the outer braid back over the cable jacket. The F-connector itself is then inserted over the prepared end of the coaxial cable. Next, the compression sleeve is compressed axially along the longitudinal axis of the connector into the body of the connector, simultaneously compressing the jacket of the coaxial cable between the compression sleeve and the tubular post of the connector. An example of such a compression sleeve F-connector is shown in U.S. Pat. No. 4,834,675 to Samchisen; such patent discloses a compression sleeve type F-connector known in the industry as “Snap-n-Seal.” A number of commercial tool manufacturers provide compression tools for axially compressing the compression sleeve into such connectors.

It is known in the coaxial cable field generally that collars or sleeves within a coaxial cable connector can be compressed inwardly against the outer surface of a coaxial cable to secure a coaxial cable connector thereto. For example, in U.S. Pat. No. 4,575,274 to Hayward, a connector assembly for a signal transmission system is disclosed wherein a body portion threadedly engages a nut portion. The nut portion includes an internal bore in which a ferrule is disposed, the ferrule having an internal bore through which the outer conductor of a coaxial cable is passed. As the nut portion is threaded over the body portion, the ferrule is wedged inwardly to constrict the inner diameter of the ferrule, thereby tightening the ferrule about the outer surface of the cable. However, the connector shown in the Hayward '274 patent can not be installed quickly, as by a simple crimp or compression tool; rather, the mating threads of such connector must be tightened, as by using a pair of wrenches. Additionally, the end of the coaxial cable must be prepared by stripping back the outer jacket and the conductive grounding sheath, all of which takes time, tools, and patience.

### SUMMARY

In one aspect, a post-less coaxial cable connector for coupling an end of a coaxial cable to a terminal, the coaxial cable comprising an inner conductor, a dielectric surrounding the inner conductor, an outer conductor surrounding the dielectric, and a jacket surrounding the outer conductor is disclosed, the post-less coaxial cable connector including a body having an internal surface extending between front and rear ends of the body, the internal surface defining a longitudinal opening, and a collapsible groove disposed between the front and rear ends, a shell having an outer surface and an internal surface, the internal surface defining an opening through the shell, the internal surface slidingly engaging at least a portion of the rear end of the body, and a compression ring disposed within the shell and engaging the rear end of the body, the compression ring having an internal surface and at least a portion of the internal surface having projections disposed around at least a portion thereof, wherein upon compression of the post-less coaxial cable connector the projections of the compression ring engage the jacket of the coaxial cable to prevent rotation of the coaxial cable relative to the post-less coaxial cable connector and a portion of the body comprising a portion of the collapsible groove is compressed radially inwardly to engage the outer conductor of the coaxial cable.

In some embodiments, upon compression of the post-less coaxial cable connector, the shell pushes the compression ring against the rear end of the body, causing the collapsible groove to be compressed axially and a portion thereof to engage the outer conductor before the compression ring is compressed radially inwardly to engage the outer jacket of the coaxial cable

In other embodiments, the post-less coaxial cable connector includes a coupling portion rotatably engaging the front end of the body.

In yet other embodiments, the compression ring and shell seal the rear end of the post-less coaxial cable connector.

In yet another aspect, a combination of a coaxial cable and a post-less coaxial cable connector for terminating an end of the coaxial cable is provided, the coaxial cable comprising an inner conductor, a dielectric surrounding the inner conductor, an outer conductor surrounding the dielectric, and a jacket surrounding the outer conductor, the post-less coaxial cable connector includes a body having an internal surface extending between front and rear ends of the body, the internal surface defining an longitudinal opening, and a collapsible groove disposed between the front and rear ends, a shell having an outer surface and an internal surface, the internal surface defining an opening therein, the internal surface slidingly engaging the rear end of the body, a compression ring disposed within the shell and engaging the rear end of the body, the compression ring having an internal surface and at least a portion of the internal surface having projections disposed around at least a portion thereof, wherein the coaxial cable extends through the shell, the compression ring, and the body, wherein the dielectric and the outer conductor terminate at the front end of the body, the inner conductor extends beyond the coupling portion and the jacket terminates about the rear end of the body.

In still yet another aspect, a method is provided for connecting a coaxial cable to a post-less coaxial cable connector, the method includes providing a post-less coaxial cable connector comprising a body having an internal surface extending between front and rear ends of the body, the internal surface defining an longitudinal opening, and a collapsible groove disposed between the front and rear ends, a shell having an outer surface and an internal surface, the internal surface defining an opening therein, the internal surface slidingly engaging the rear end of the body, and a compression ring disposed within the shell and engaging the rear end of the body, the compression having an internal surface and at least a portion of the internal surface having projections disposed around at least a portion thereof, providing a coaxial cable comprising an inner conductor, a dielectric surrounding the inner conductor, an outer conductor surrounding the dielectric, and a jacket surrounding the outer conductor, preparing the coaxial cable by exposing a predetermined length of the center conductor and a predetermined length of the outer conductor, the outer conductor covering the underlying dielectric, inserting the prepared coaxial cable into the shell, the compression ring, and the body, wherein the dielectric and the outer conductor terminate at the front end of the body, the inner conductor extends beyond the coupling portion and the jacket terminates about the rear end of the body, axially compressing the post-less coaxial cable connector thereby causing the shell to push the compression ring against the rear end of the body, causing the collapsible groove to be compressed axially and a portion thereof to engage the outer conductor before the compression ring is compressed radially inwardly by the shell to engage the outer jacket of the coaxial cable.

Additional features and advantages of the invention will be set forth in the detailed description which follows, and in part will be readily apparent to those skilled in the art from that description or recognized by practicing the invention as described herein, including the detailed description, which follows, the claims, as well as the appended drawings.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a partial cross section of a coaxial cable useful for description of the various cable constituents;

FIG. 1A is a partial cross section of a prepared coaxial cable using prior art preparation methods;

FIG. 1B is a partial cross section of a prior art coaxial connector utilizing a post with a coaxial cable installed;

FIG. 2 is a cross sectional view of one embodiment of a post-less coaxial cable connector according to the present invention;

FIG. 3 is a partial cross section of a prepared coaxial cable using one method of preparation according to the present invention;

FIG. 4 is a cross section of the post-less coaxial cable connector of FIG. 2 in an un-compressed or open condition with the prepared coaxial cable of FIG. 3 inserted therein;

FIG. 5 is a cross section of the post-less coaxial cable connector and prepared coaxial cable of FIG. 4 in a first stage of compression; and

FIG. 6 is a partial cross section of the post-less coaxial cable connector and prepared coaxial cable of FIG. 4 in a second and final stage of compression.

### DETAILED DESCRIPTION

Reference will now be made in detail to the present preferred embodiment(s) of the invention, examples of which are illustrated in the accompanying drawings. Whenever possible, the same reference numerals will be used throughout the drawings to refer to the same or like parts.

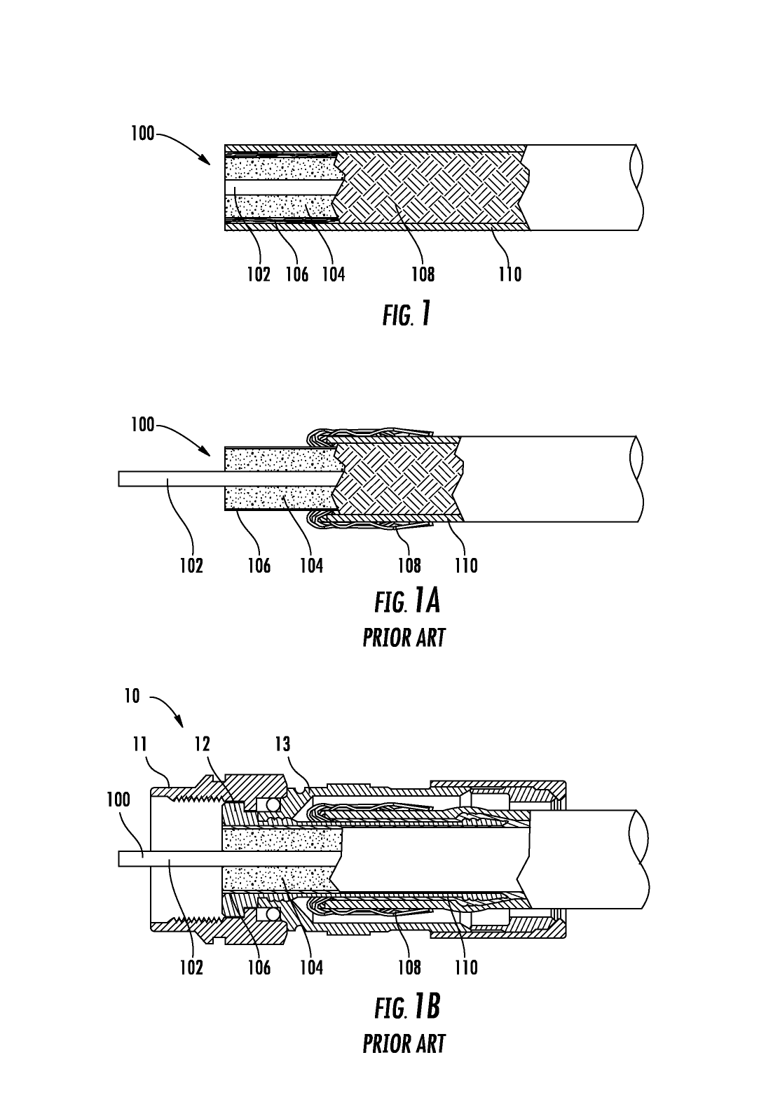

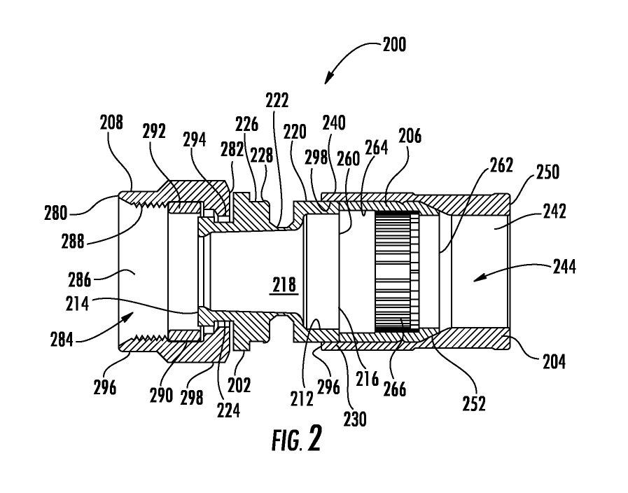

Referring to FIGS. 1, 1A, and 1B, a prior art coaxial cable 100 is illustrated and the method in which the end of the coaxial cable 100 is prepared. Referring to FIG. 1, the coaxial cable 100 has a center conductor 102 that is surrounded by a dielectric layer 104. The dielectric layer (or dielectric) 104 may also have a foil or other metallic covering 106. Coaxial cable 100 then has a braided outer conductor 108 which is covered and protected by a jacket 110. Typically, to prepare the coaxial cable 100 for attachment to a coaxial cable connector, a portion of the center conductor 102 is exposed as illustrated in FIG. 1A. The jacket 110 is trimmed back so that a portion of the dielectric 104 (and metallic covering 106) and braided outer conductor 108 are exposed. The braided outer conductor 108 is then folded back over the jacket 110, to expose the dielectric (and the metallic covering 106 if present).

FIG. 1B illustrates the prepared coaxial cable of FIG. 1A inserted into a prior art coaxial connector 10. The connector 10 has a coupling 11 beyond which the center conductor 102 extends and is attached to a body portion 13. Inside the body portion 13 is a post 12, the post 12 is used to secure the coaxial cable 100 relative to the coaxial connector 10. As can be seen in FIG. 1B, the post 12 is inserted into the cable 100 between the braided outer conductor 108 and the dielectric 104. The post 12 can cause problems for the coaxial connector 10 as well as the installer. First, the coaxial cable 100 must be prepared and then the post 12 must be inserted into the coaxial cable 100. Second, the post 12 can skive the coaxial cable 100, tear the braided outer conductor 108 or the jacket 110. Additionally, it can be difficult to insert the post 12 into the coaxial cable 100.

One embodiment of a post-less coaxial cable connector 200 according to the present invention is illustrated in FIG. 2. The post-less coaxial cable connector 200 has a body 202, a shell 204, a compression ring 206, and a coupling portion 208. It should be noted that the post-less coaxial cable connector 200 does not have a post that engages the coaxial cable between the dielectric and the outer conductor as illustrated above. The body 202 has an internal surface 212 that extends between the front end 214 and the rear end 216 that defines a longitudinal opening 218. The body 202 also has an outer surface 220 that has a collapsible groove 222 positioned between the front end 214 and the rear end 216. The body 202 also has an annular groove 224 disposed adjacent the front end 214 to engage and retain the coupling portion 208, described in more detail below. Disposed between the annular groove 224 and the collapsible groove 222 is retaining groove 226 with a forward facing surface 228 that engages and retains the shell 204 in a compressed state as described below. The outer surface 220 also has an annular projection 230 adjacent the rear end 216 of body 202 to prevent the shell 204 from falling off the rear end 216. The body 202 is preferably made from brass, but may be made from any appropriate material.

The shell 204 has an outer surface 240 and an internal surface 242, the internal surface 242 defining an opening 244 therethrough. The shell 204 has at front end 246 an annular ring 248 to engage and be retained on the body 202 by the annular projection 230. As can be seen in FIG. 2, the opening 244 is wider at the front end 246 than at the back end 250 due to the forward and inward facing surface 252. The shell 204 is preferably also made from brass, but may be made from any appropriate material.

The compression ring 206 is disposed within the opening 244 of the shell 204. The compression ring 206 has a front end 260 and a rear end 262. The front end 260 is preferably disposed against the rear end 216 of the body 202 and the rear end 262 is disposed against the surface 252 of the shell 204. The compression ring 206 has an internal surface 264 that also includes a ring of projections 266. The projections 266 are preferably disposed completely around the circumference of the internal surface 264 as illustrated in FIG. 2. However, they may go only partially around the internal surface 264 or be intermittently disposed around the internal surface 264. Additionally, the projections 266 need only extend along a portion of the length of the compression ring 206, but may extend along the entirety thereof or be present in several places. The projections 266 serve to engage the outer jacket of the coaxial cable to prevent rotation of the coaxial cable relative to the post-less coaxial cable connector 200. The compression ring 206 is preferably made from a plastic material (a polymer), but may be made of any appropriate material.

The coupling portion 208 has a front end 280, a back end 282, and an opening 284 extending there between. The opening 284 of the coupling portion 208 has an internal surface 286. The internal surface 286 includes a threaded portion 288 and a channel 290. The channel 290 is configured to receive an elastic ring 292 to seal the post-less coaxial cable connector 200. The coupling portion 208 also an inwardly projecting ring 294 to engage the annular groove 224 disposed adjacent the front end 214 of body 202. The coupling portion 208 also has a smooth outer surface 296 adjacent the front end 280 and a hexagonal configuration 298 adjacent the back end 282. The coupling portion 208 is preferably made from a metallic material, such as brass, and it is plated with a conductive, corrosion-resistant material, such as nickel, but it may be made from any appropriate material.

FIG. 3 illustrates a coaxial cable 300 in a prepared state for use with the the post-less coaxial cable connector 200. The coaxial cable 300 is substantially like the coaxial cable 100 noted above, it is just different in how the cable end is prepared for use. As illustrated in FIG. 3, the coaxial cable has a center conductor 302 that is surrounded by a dielectric layer 304. Coaxial cable 300 then has a braided outer conductor 308 which is covered and protected by a jacket 310. In FIG. 3, the dielectric layer 304 is not visible as it may be cut flush with, and, thereby, covered by, the braided outer conductor 308. The dielectric layer (or dielectric) 304 may also have a foil or other metallic covering (also covered by braided outer conductor 308). The braided outer conductor 308 is illustrated as having a parquet-floor-like pattern, but it may be any outer conductor. From the end 312 of the coaxial cable 300, the center conductor 302 is exposed by removing the dielectric layer 304, the foil or other metallic covering, the braided outer conductor 308 and the jacket 310. A second portion of the coaxial cable 300 then has only the jacket 310 removed, leaving the dielectric layer 304, the foil or other metallic covering and the braided outer conductor 308 intact. As noted above, the prior art required that the braided outer conductor 308 be folded back over the jacket 310. This preparation requires less time than the other method of preparation.

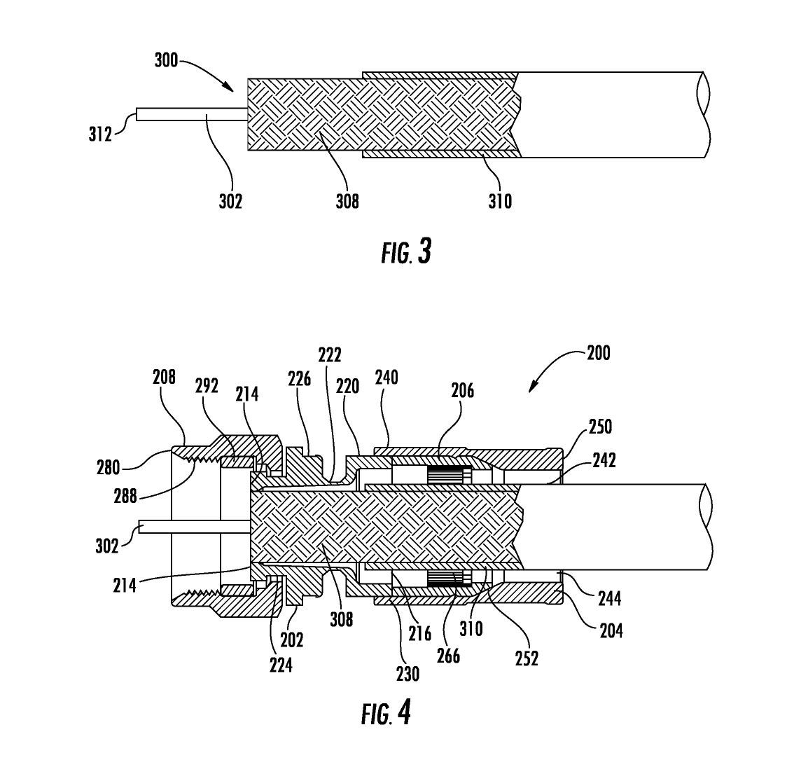

The assembly of the post-less coaxial cable connector 200 will now be discussed with reference to FIGS. 4-6. As can be seen in FIG. 4, the prepared coaxial cable 300 is inserted through the opening 244 of the shell 204, through the compression ring 206, and into the body 202, wherein the dielectric 304 and the outer conductor 308 terminate at the front end 214 of the body 202. The inner conductor 302 extends through and beyond the coupling portion 208, while the jacket 310 terminates about the rear end 216 of the body 202.

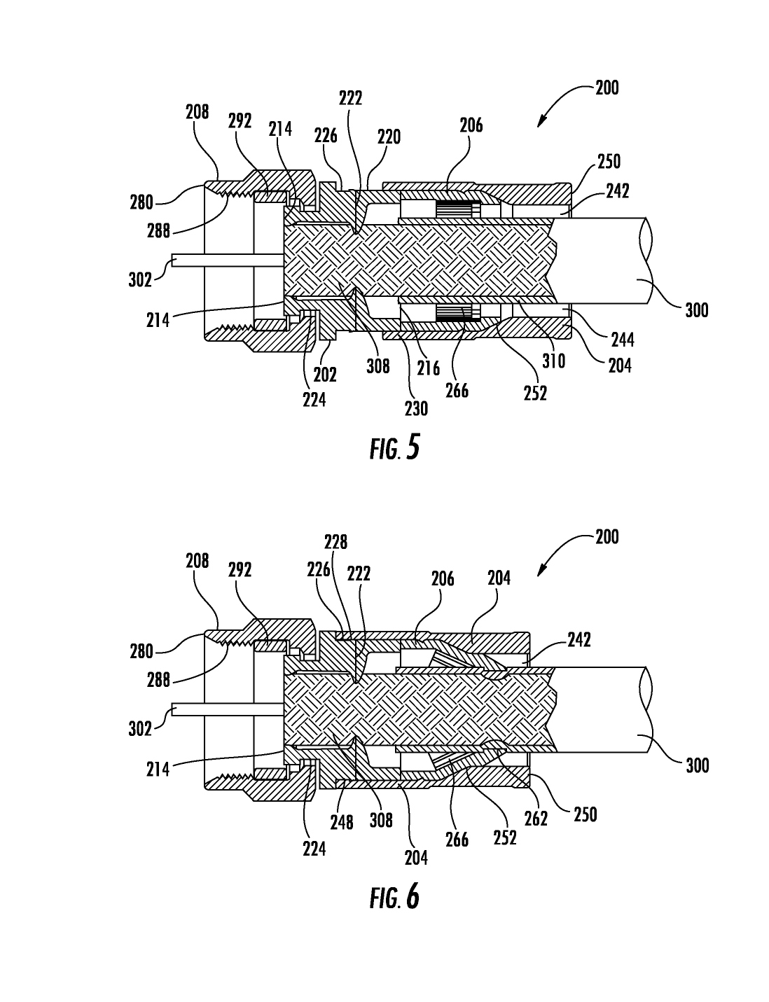

FIG. 5 illustrates the post-less coaxial cable connector 200 as it is being partially axially compressed. The axial compression tool is not illustrated to allow for clarity of the figures. As the tool engages the rear end 250 of the shell 204 (and the front end 280 of the coupling portion 208), the shell 204 engages the compression ring 206 by way of the surface 252 and drives it forward. As the front end of the compression ring 206 is disposed against the rear end 216 of the body 202, it drives the rear end 216 of the body 202 towards the front of the body 202. This causes the collapsible groove 222 to collapse and drives a portion of the body 202 radially inward to engage the coaxial cable 300 and in particular the outer conductor 308 and the dielectric 304 underneath the outer conductor 308. This engagement of the body 202 with the coaxial cable 300 provides appropriate pull strength for the coaxial cable 300. The body 202 and the outer conductor 308 are also in electrical communication with one another as required.

In FIG. 6, the axial compression of the post-less coaxial cable connector 200 has been completed. As can be seen, the shell 204 has been moved axially forward even more than in FIG. 5, and the surface 252 has caused the compression ring 206 to be forced radially inward against the coaxial cable 300 and the jacket 310 in particular. Since the compression ring 206 was fully engaged with the body 202, when the collapsible groove was compressed and narrowed, the shell 204 had to move relative to the compression ring 206 and the surface 252 pushed the compression ring 206 and the projections 266 into the jacket 310. These projections 266 grab the jacket 310 and provide appropriate anti-rotation torque. Since the compression ring 206 is pushed radially inward into the jacket 310, it forms a seal at the rear end of the post-less coaxial cable connector 200.

The annular ring 248 of the shell 204 engages the retaining groove 226 of body 202 and the forward facing surface 228 of retaining groove 226 prevents the backward movement of the shell 204 relative to the body 202.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A post-less coaxial cable connector for coupling an end of a coaxial cable to a terminal, the coaxial cable comprising an inner conductor, a dielectric surrounding the inner conductor, an outer conductor surrounding the dielectric, and a jacket surrounding the outer conductor, the post-less coaxial cable connector comprising:
a body having an internal surface extending between front and rear ends of the body, the internal surface defining a longitudinal opening, and a collapsible groove disposed between the front and rear ends;
a shell having an outer surface and an internal surface, the internal surface defining an opening through the shell, the internal surface slidingly engaging at least a portion of the rear end of the body; and
a compression ring disposed within the shell and engaging the rear end of the body, the compression ring having an internal surface and at least a portion of the internal surface having projections disposed around at least a portion thereof,
wherein upon compression of the post-less coaxial cable connector the projections of the compression ring engage the jacket of the coaxial cable to prevent rotation of the coaxial cable relative to the post-less coaxial cable connector and a portion of the body comprising a portion of the collapsible groove is compressed radially inwardly to engage the outer conductor of the coaxial cable.

2. The post-less coaxial cable connector according to claim 1, wherein upon compression of the post-less coaxial cable connector, the shell pushes the compression ring against the rear end of the body, causing the collapsible groove to be compressed axially and a portion thereof to engage the outer conductor before the compression ring is compressed radially inwardly to engage the outer jacket of the coaxial cable.

3. The post-less coaxial cable connector according to claim 1, further comprising a coupling portion rotatably engaging the front end of the body.

4. The post-less coaxial cable connector according to claim 3, further comprising an elastic ring disposed in an opening of the coupling portion to seal the front end of the post-less coaxial cable connector.

5. The post-less coaxial cable connector according to claim 1, wherein the internal surface of the compression ring has projections disposed around a circumference thereof.

6. The post-less coaxial cable connector according to claim 1, wherein the collapsible groove is disposed in an outer surface of the body.

7. The post-less coaxial cable connector according to claim 2, wherein the compression ring and shell seal the rear end of the post-less coaxial cable connector.

8. A combination of a coaxial cable and a post-less coaxial cable connector for terminating an end of the coaxial cable, the coaxial cable comprising an inner conductor, a dielectric surrounding the inner conductor, an outer conductor surrounding the dielectric, and a jacket surrounding the outer conductor, the post-less coaxial cable connector comprising:
a body having an internal surface extending between front and rear ends of the body, the internal surface defining an longitudinal opening, and a collapsible groove disposed between the front and rear ends;
a shell having an outer surface and an internal surface, the internal surface defining an opening therein, the internal surface slidingly engaging the rear end of the body; and
a compression ring disposed within the shell and engaging the rear end of the body, the compression ring having an internal surface and at least a portion of the internal surface having projections disposed around at least a portion thereof,
wherein the coaxial cable extends through the shell, the compression ring, and the body, wherein the dielectric and the outer conductor terminate at the front end of the body, the inner conductor extends beyond the coupling portion and the jacket terminates about the rear end of the body.

9. The combination of a coaxial cable and a post-less coaxial cable connector according to claim 8, wherein upon compression of the post-less coaxial cable connector, the shell pushes the compression ring against the rear end of the body, causing the collapsible groove to be compressed axially and a portion thereof to engage the outer conductor before the compression ring is compressed radially inwardly to engage the outer jacket of the coaxial cable.

10. The combination of a coaxial cable and a post-less coaxial cable connector according to claim 8, further comprising a coupling portion rotatably engaging the front end of the body.

11. The combination of a coaxial cable and a post-less coaxial cable connector according to claim 8, further comprising an elastic ring disposed in an opening of the coupling portion to seal the front end of the post-less coaxial cable connector.

12. The combination of a coaxial cable and a post-less coaxial cable connector according to claim 8, wherein the internal surface of the compression ring has projections disposed around a circumference thereof.

13. The combination of a coaxial cable and a post-less coaxial cable connector according to claim 8, wherein the collapsible groove is disposed in an outer surface of the body.

14. The combination of a coaxial cable and a post-less coaxial cable connector according to claim 8, wherein the compression ring and shell seal the rear end of the post-less coaxial cable connector.

15. A method for connecting a coaxial cable to a post-less coaxial cable connector, the method comprising:
providing a post-less coaxial cable connector comprising a body having an internal surface extending between front and rear ends of the body, the internal surface defining an longitudinal opening, and a collapsible groove disposed between the front and rear ends, a shell having an outer surface and an internal surface, the internal surface defining an opening therein, the internal surface slidingly engaging the rear end of the body, and a compression ring disposed within the shell and engaging the rear end of the body, the compression having an internal surface and at least a portion of the internal surface having projections disposed around at least a portion thereof;
providing a coaxial cable comprising an inner conductor, a dielectric surrounding the inner conductor, an outer conductor surrounding the dielectric, and a jacket surrounding the outer conductor;
preparing the coaxial cable by exposing a predetermined length of the center conductor and a predetermined length of the outer conductor, the outer conductor covering the underlying dielectric;
inserting the prepared coaxial cable into the shell, the compression ring, and the body, wherein the dielectric and the outer conductor terminate at the front end of the body, the inner conductor extends beyond the coupling portion and the jacket terminates about the rear end of the body;
axially compressing the post-less coaxial cable connector thereby causing the shell to push the compression ring against the rear end of the body, causing the collapsible groove to be compressed axially and a portion thereof to engage the outer conductor before the compression ring is compressed radially inwardly by the shell to engage the outer jacket of the coaxial cable.
